(19) United States
(12) Patent Application Publication
(10) Pub. No.: US 2006/0286277 A1
(43) Pub. Date: Dec. 21, 2006

(54) Method for making a spice sugar cube

(76) Inventor: Andranik V. Masihi, La Crescenta, CA (US)

Correspondence Address: AVERILL & VARN, 8244 PAINTER AVE., WHITTIER, CA, 90602, US

(21) Appl. No.: 11/142,730

(22) Filed: Jun. 1, 2005

(51) Int. Cl. A23L 1/221

(52) U.S. Cl. 426/650

(57) ABSTRACT

A method for making a high quality spice sugar cube. The spice sugar cube consists essentially of sugar or a sugar substitute and at least one spice. A quantity of spice and a volume of sugar are measured. A first portion of about one third of the volume of sugar is dissolved in water to create a sugar water solution. The sugar water solution is heated until the solution reaches a temperature between 215 and 235 degrees Fahrenheit resulting in an amount of the water evaporating (e.g., boiling out) from the solution. The solution is than allowed to cool to between 80 and 120 degrees Fahrenheit. The quantity of spice is then mixed into the solution, and then the remaining portion of the volume of sugar is mixed into the solution to form a mixture. The mixture is then poured into a flat pan and pressed to remove any voids and cut into cubes.

### BACKGROUND OF THE INVENTION

The present invention relates to dissolving spice sugar cubes and more particularly to high quality cinnamon sugar cubes suitable for dissolving in a beverage.

Various cultures enjoy flavoring beverages with a combination of sugar and cinnamon, or sugar and some other spice. Although cinnamon may be introduced into the drink in various way, for example, cinnamon sticks, using a cinnamon sugar cube is a more desirable method. There is also a perception that a firm and slow to dissolve spice sugar cube is a higher quality cube. Unfortunately, commonly made sugar cubes do not include this characteristic.

### BRIEF SUMMARY OF THE INVENTION

The present invention addresses the above and other needs by providing a method for making a high quality spice sugar cube. The spice sugar cube consists essentially of sugar or a sugar substitute and at least one spice. A volume of sugar and a corresponding quantity of spice are measured. A first portion of preferably about ⅓ of the volume of sugar is dissolved in a volume of water to create a sugar water solution. The sugar water solution is heated until the solution reaches a temperature between 215 and 235 degrees Fahrenheit resulting in an amount of the water evaporating (e.g., boiling out) from the solution. The solution is than allowed to cool to between 80 and 120 degrees Fahrenheit. The quantity of spice is then mixed into the solution, and then the remaining approximately two thirds portion of the volume of sugar is mixed with the solution to provide a sugar/spice mixture. The mixture is then poured into a flat pan and pressed to remove any voids and cut into cubes.

In accordance with one aspect of the invention, there is provided a method for making a cinnamon sugar cube. The method comprising ordered steps of: measuring a volume of sugar; measuring a one percent to a five percent by volume quantity of cinnamon with respect to the volume of sugar; mixing a first portion of the volume of sugar with a volume of water to create a solution; boiling the solution to between 215 degrees Fahrenheit and 235 degrees Fahrenheit; cooling the solution to between 80 degrees Fahrenheit and 120 degrees Fahrenheit; mixing the quantity of spice into the solution; mixing the remaining sugar into the solution to provide a sugar/cinnamon mixture; pouring the mixture into a pan; pressing the mixture to reduce voids; and cutting the mixture into cubes. The first portion of the volume of sugar is preferably between ¼ to ⅖ of the volume of sugar and more preferably ⅓ of the volume of sugar. The volume of water is preferably between approximately five liters of water and approximately ten liters of water per 100 pounds of the first portion of the volume of sugar, and more preferably approximately seven liters of water per 100 pounds of the first portion of the volume of sugar.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a spice sugar cube according to the present invention.

FIG. 2 is a method for making a spice sugar cube according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

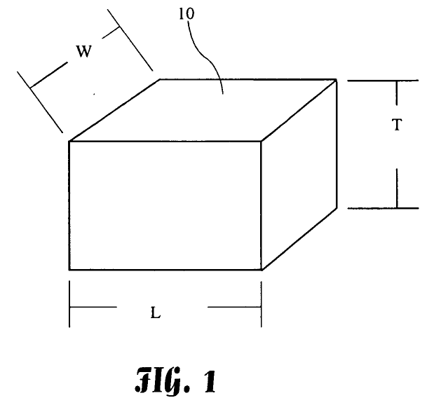

A spice sugar cube 10 according to the present invention is shown in FIG. 1. The spice sugar cube 10 is a high quality spice sugar cube which dissolves slowly in a drink, for example, in tea. The spice sugar cube 10 is of a size convenient for handling and for placing into a drink, and preferably has a length L of approximately ½ inches, a width W of approximately ½ inches, and a thickness T of approximately ⅜ inches.

The spice sugar cube 10 consists essentially of sugar and one or more of a group of spices consisting of rosemary, cinnamon, cardamom, clove, nutmeg, mint, lemon, orange extract, ginger, and citric acid, and preferably includes cinnamon. More preferably, the spice sugar cube 10 consists essentially of sugar and a quantity of spice selected from a group consisting of a one percent to a five percent by volume quantity of rosemary, a one percent to a five percent by volume quantity of cinnamon, a one percent to a five percent by volume quantity of cardamom, a one percent to a five percent by volume quantity of clove, a one percent to a five percent by volume quantity of nutmeg, a one percent to a five percent by volume quantity of mint, a one percent to a five percent by volume quantity of lemon, a one percent to a five percent by volume quantity of orange extract, a one percent to a five percent by volume quantity of ginger, and a 0.1 percent to a one percent by volume quantity of citric acid.

Most preferably, the spice sugar cube 10 consists essentially of sugar and a quantity of spice selected from a group consisting of an approximately three percent by volume quantity of rosemary, an approximately three percent by volume quantity of cinnamon, an approximately three percent by volume quantity of cardamom, an approximately three percent by volume quantity of clove, an approximately three percent by volume quantity of nutmeg, an approximately three percent by volume quantity of mint, an approximately three percent by volume quantity of lemon, an approximately three percent by volume quantity of orange extract, an approximately two percent by volume quantity of ginger, and an approximately 0.25 percent by volume quantity of citric acid, all measured as a percentage of the sugar.

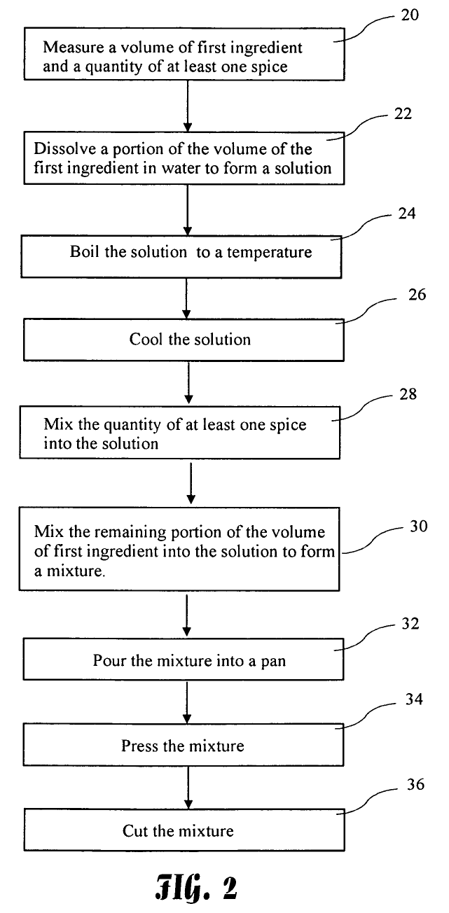

A method for making the spice sugar cube 10 according to the present invention is described in FIG. 2. The method includes the steps of measuring a volume of first ingredient and a corresponding quantity of at least one spice at step 20, dissolving a first portion of the volume of first ingredient in water to form a solution at step 22, boiling the solution until the solution reaches a first temperature at step 24, cooling the solution until the solution reaches a second temperature at step 26, mixing the quantity of at least one spice into the solution at step 28, mixing a remaining portion of the volume of first ingredient into the solution to provide a first ingredient/spice mixture at step 30, pouring the mixture into a pan at step 32, pressing the mixture to reduce voids in the mixture at step 34, and cutting the mixture at step 36.

The first ingredient is preferably sugar or a sugar substitute, is more preferably sugar, and is most preferably granulated sugar. Examples of sugar substitutes are Equal® sweetener, Splendra® sweetener, Weight Watchers® sweetener, and Natra Taste® sweetener. The first portion of the volume of the first ingredient is preferably between ¼ to ⅖ of the volume of the first ingredient and more preferably ⅓ of the volume of the first ingredient. The volume of water is preferably between approximately five liters of water and approximately ten liters of water per 100 pounds of the first portion of the volume of the first ingredient, and more preferably approximately seven liters of water per 100 pounds of the first portion of the volume of the first ingredient. The first ingredient and water solution is preferably heated to between 215 degrees Fahrenheit and 235 degrees Fahrenheit, and more preferably to approximately 220 degrees Fahrenheit, while monitoring the temperature of the solution.

The at least one spice is selected from a group consisting of rosemary, cinnamon, cardamom, clove, nutmeg, mint, lemon, orange extract, ginger, and citric acid. Preferably, measuring the quantity of the at least on spice is selected from a group consisting of measuring a one percent to a five percent by volume quantity of rosemary, measuring a one percent to a five percent by volume quantity of cinnamon, measuring a one percent to a five percent by volume quantity of cardamom, measuring a one percent to a five percent by volume quantity of clove, measuring a one percent to a five percent by volume quantity of nutmeg, measuring a one percent to a five percent by volume quantity of mint, measuring a one percent to a five percent by volume quantity of lemon, measuring a one percent to a five percent by volume quantity of orange extract, measuring a one percent to a five percent by volume quantity of ginger, and measuring a 0.1 percent to a one percent by volume quantity of citric acid.

More preferably, measuring the quantity of the at least on spice is selected from a group consisting essentially of measuring an approximately three percent by volume quantity of rosemary, measuring an approximately three percent by volume quantity of cinnamon, measuring an approximately three percent by volume quantity of cardamom, measuring an approximately three percent by volume quantity of clove, measuring an approximately three percent by volume quantity of nutmeg, measuring an approximately three percent by volume quantity of mint, measuring an approximately three percent by volume quantity of lemon, measuring an approximately three percent by volume quantity of orange extract, measuring an approximately two percent by volume quantity of ginger, and measuring an approximately 0.25 percent by volume quantity of citric acid, all measured as a percentage of the sugar.

While the invention herein disclosed has been described by means of specific embodiments and applications thereof, numerous modifications and variations could be made thereto by those skilled in the art without departing from the scope of the invention set forth in the claims.

I claim:

1. A method for making a spice sugar cube, the method comprising:
measuring a volume of a sweetener selected from a group consisting of sugar and a sugar substitute;
measuring a quantity of spice;
mixing a portion of the volume of sweetener with water to create a solution;
boiling the solution to between 215 degrees Fahrenheit and 235 degrees Fahrenheit;
cooling the solution to between 80 degrees Fahrenheit and 120 degrees Fahrenheit;
mixing the quantity of spice into the solution;
mixing the remaining sweetener into the solution to provide a sweetener/spice mixture;
pouring the sweetener/spice mixture into a pan; and
cutting the sweetener/spice mixture into cubes.

2. The method of claim 1, wherein mixing a portion of the volume of sweetener with water comprises mixing between approximately ¼ of the volume of sweetener and approximately ⅖ of the volume of sweetener with a volume of water of between approximately five liters and approximately ten liters of water per 100 pounds of the portion of the volume of sweetener.

3. The method of claim 2, wherein mixing a portion of the volume of sweetener with water comprises mixing approximately ⅓ of the volume of sweetener with the volume of water.

4. The method of claim 3, wherein measuring a volume of a sweetener comprises measuring a volume of sugar.

5. The method of claim 3, wherein mixing approximately ⅓ of the volume of sweetener with a volume of water comprises mixing approximately ⅓ of the volume of sweetener with a volume of water of approximately seven liters of water per 100 pounds of the approximately ⅓ of the volume of sweetener.

6. The method of claim 1, wherein the spice is selected from a group consisting of rosemary, cinnamon, cardamom, clove, nutmeg, mint, lemon, orange extract, ginger, and citric acid.

7. The method of claim 6, wherein measuring a quantity of spice comprises measuring a quantity of spice selected from a group consisting of measuring a one percent to a five percent by volume quantity of rosemary, a one percent to a five percent by volume quantity of cinnamon, a one percent to a five percent by volume quantity of cardamom, a one percent to a five percent by volume quantity of clove, a one percent to a five percent by volume quantity of nutmeg, a one percent to a five percent by volume quantity of mint, a one percent to a five percent by volume quantity of lemon, a one percent to a five percent by volume quantity of orange extract, a one percent to a five percent by volume quantity of ginger, and a 0.1 percent to a one percent by volume quantity of citric acid.

8. The method of claim 6, wherein the spice is cinnamon.

9. The method of claim 8, wherein measuring a quantity of spice comprises measuring a one percent to a five percent by volume quantity of cinnamon.

10. The method of claim 9, wherein measuring a quantity of spice comprises measuring an approximately three percent by volume quantity of cinnamon.

11. The method of claim 9, wherein measuring a quantity of sweetener comprises measuring a quantity of sugar.

12. The method of claim 11, wherein measuring a quantity of sugar comprises measuring a quantity of granulated sugar.

13. The method of claim 1, further including after pouring the sugar/spice mixture into a pan, pressing the mixture to reduce voids.

14. A method for making a cinnamon cube, the method comprising ordered steps:
a. measuring a volume of sugar
b. measuring a one percent to five percent by volume quantity of cinnamon with respect to the volume of sugar;
c. mixing between approximately ¼ and approximately ⅖ of the volume of sugar with water to create a solution;
d. boiling the solution to between 215 degrees Fahrenheit and 235 degrees Fahrenheit;
e. cooling the solution to between 80 degrees Fahrenheit and 120 degrees Fahrenheit;
f. mixing the quantity of cinnamon into the solution;
g. mixing the remaining sugar into the solution to provide a sugar/spice mixture;
h. pouring the sugar/spice mixture into a pan;
l. pressing the sugar/spice mixture to reduce voids; and
j. cutting the sugar/spice mixture into cubes.

15. The method of claim 14, wherein mixing between approximately ¼ and approximately ⅖ of the volume of sugar with water to create a solution comprises mixing between approximately ¼ and approximately ⅖ of the volume of sugar with a volume of water of between approximately five liters of water per 100 pounds and approximately ten liters of water per 100 pounds of the between approximately ¼ and approximately ⅖ of the volume of sugar to create a solution.

16. The method of claim 15, wherein mixing between approximately ¼ and approximately ⅖ of the volume of sugar with water to create a solution comprises mixing between approximately ⅓ of the volume of sugar with a volume of water of approximately seven liters of water per 100 pounds of the ⅓ of the volume of sugar to create a solution.

17. A high quality spice sugar cube made by the process of:
a. measuring a volume of sugar
b. measuring a one percent to a five percent by volume quantity of cinnamon with respect to the volume of sugar;
c. mixing between approximately ¼ and approximately ⅖ of the volume of sugar with water to create a solution;
d. boiling the solution to between 215 degrees Fahrenheit and 235 degrees Fahrenheit;
e. cooling the solution to between 80 degrees Fahrenheit and 120 degrees Fahrenheit;
f. mixing the quantity of spice into the solution;
g. mixing the remaining sugar into the solution to provide a sugar/spice mixture;
h. pouring the sugar/spice mixture into a pan;
l. pressing the sugar/spice mixture to reduce voids; and
j. cutting the sugar/spice mixture into cubes.

18. The product of claim 17, wherein mixing between approximately ¼ and approximately ⅖ of the volume of sugar with water to create a solution comprises mixing between approximately ¼ and approximately ⅖ of the volume of sugar with a volume of water of between approximately five liters of water per 100 pounds and approximately ten liters of water per 100 pounds of the between approximately ¼ and approximately ⅖ of the volume of sugar to create a solution.

19. The product of claim 18, wherein mixing between approximately ¼ and approximately ⅖ of the volume of sugar with water to create a solution comprises mixing between approximately ⅓ of the volume of sugar with a volume of water of approximately seven liters of water per 100 pounds of the ⅓ of the volume of sugar to create a solution.
